(19) United States
(12) Patent Application Publication
(10) Pub. No.: US 2017/0106731 A1
(43) Pub. Date: Apr. 20, 2017

(54) WEATHER STRIP WITH REPLACEABLE SEALING COMPONENT

(71) Applicant: Hyundai Motor Company, Seoul (KR)

(72) Inventors: Bum-Suk Kang, Ansan (KR); Seung-Hyun Baek, Suwon (KR)

(21) Appl. No.: 15/259,404

(22) Filed: Sep. 8, 2016

(30) Foreign Application Priority Data
Oct. 15, 2015 (KR) 10-2015-0144064

(51) Int. Cl. B60J 10/33; B60J 10/24; B60J 10/50; E06B 7/16

(52) U.S. Cl. CPC B60J 10/33; E06B 7/16; B60J 10/24; B60J 10/50

(57) ABSTRACT

A weather strip with a replaceable sealing component is provided. The weather strip includes a flange holding component that holds a body flange of a vehicle body, with a frame installed in the flange holding component, and a sealing component that has a convex curved shape and is connected at opposite edges thereof to the flange holding component. When a vehicle is manufactured, the sealing component is formed as an initial sealing component integrally formed with the flange holding component to be removable from the flange holding component. After removal of the initial sealing component from the flange holding component, opposite edges of a replacement sealing component having an outwardly convex shape are coupled to the respective opposite edges of the flange holding component. Accordingly, the replacement sealing component is substituted for the initial sealing component.

### CROSS-REFERENCE TO RELATED APPLICATIONS

This application claims priority to Korean Patent Application No. 10-2015-0144064, filed on Oct. 15, 2015, which is incorporated herein by reference in its entirety.

### BACKGROUND

Field of the Invention

The present invention relates to a weather strip installed on a portion of a vehicle where a door is installed and more particularly, to a weather strip with a replaceable sealing component that prevents entry of foreign substances or transfer of noise into the passenger compartment.

Description of Related Art

Generally, weather strips are disposed on portions of vehicles where doors are installed to prevent foreign substances or noise from entering passenger compartments from the exterior. As shown in FIG. 1, a weather strip 110 for sealing a passenger compartment of a vehicle from the exterior is installed on a portion of the vehicle body that contacts the perimeter of a door.

A process of installing the weather strip 110 and an interior trim 3 for a passenger compartment of a vehicle will be described in brief. As shown in FIG. 2, a flange holding component 112 having a frame 114 therein is fixed to a body flange 2 formed in a vehicle body. The trim 3 is mounted to the vehicle body. A pull cord 13a is subsequently pulled to expose a trim holding component 113 of the weather strip 110 out of the trim 3 and to dispose on an exterior surface of the trim 3, thus completing the installation of the weather strip 110 and the trim 3.

As the weather strip 110 is installed on the portion of the vehicle body on which a door is installed, a sealing component 111 of the weather strip 110 seals a space between the vehicle body and the door to prevent foreign substances or noise from entering the passenger compartment from the exterior. The trim holding component 113 of the weather strip 110 is disposed on the exterior of the trim 3, thus finishing the interior of the passenger compartment.

However, the conventional weather strip 110 that uses the pull cord method is problematic when replacement of the weather strip 110 is required. In particular, due to contamination, defect, damage or the like of the weather strip 110, the entirety of the trim 3 must be removed before the weather strip 110 is replaced. Furthermore, since both the weather strip 110 and the trim 3 that have been installed on the vehicle body must be removed to replace the weather strip, significant time and costs are required.

The above information disclosed in this section is merely for enhancement of understanding of the background of the invention and therefore it may contain information that does not form the prior art that is already known in this country to a person of ordinary skill in the art.

### SUMMARY

The present invention provides a weather strip with a replaceable sealing component. For example, when replacement of the weather strip is required due to contamination, defect, damage, etc., the sealing component may be replaced with a new sealing component while the other components remain unchanged.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an exemplary embodiment of the present invention, a weather strip with a replaceable sealing component may include a flange holding component configured to hold a body flange of a vehicle body, having a frame installed in the flange holding component and a sealing component having a convex curved shape and connected at opposite edges thereof to the flange holding component. Further, when a vehicle is manufactured, the sealing component may be formed as an initial sealing component integrally formed with the flange holding component and may to be removable from the flange holding component. After removal of the initial sealing component from the flange holding component, opposite edges of a replacement sealing component having an outwardly convex shape may be coupled to the respective opposite edges of the flange holding component. Accordingly, the replacement sealing component may be substituted for the initial sealing component.

A cut out portion may be formed in a junction between the initial sealing component and the flange holding component. The cut out portion may have a cross-sectional area that is less than cross-sectional areas of the other portions. The initial sealing component may be separated from the flange holding component at the cut out portion.

Additionally, locking hooks and coupling hooks may be respectively formed on the opposite edges of the flange holding component and the opposite edges of the replacement sealing component coupled with each other. The replacement sealing component may be coupled to the flange holding component by coupling the locking hooks formed on the flange holding component with the coupling hooks formed on the replacement sealing component. The locking hooks and the coupling hooks may have a hardness greater than that of the other portions of the replacement sealing component and the flange holding component. The locking hooks and the coupling hooks may be formed from thermoplastic elastomer (TPE) or ethylene propylene diene monomer (EPDM).

A replacement trim-holding component may extend from a predetermined portion of the replacement sealing component and may contact an interior trim. The interior trim may be disposed in a passenger compartment of the vehicle and may have an edge disposed adjacent to the replacement sealing component.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is an exemplary front view showing a weather strip installed on a portion of a vehicle to which a door is mounted according to the related art;

FIG. 2 is an exemplary schematic view illustrating a process of installing a pull cord type weather strip on a vehicle according to a conventional technique of the related art;

FIG. 3 is an exemplary sectional view showing the pull cord type weather strip installed on the vehicle according to the conventional technique of the related art;

FIG. 4 is an exemplary sectional view illustrating a weather strip with a replaceable sealing component that is installed on a vehicle when the vehicle is manufactured according to an exemplary embodiment of the present invention;

FIGS. 5 and 6 are exemplary enlarged views of respective portions A and B of FIG. 4 according to an exemplary embodiment of the present invention;

FIG. 7 is an exemplary sectional view illustrating a process of replacing the sealing component of the weather strip with a new one according to an exemplary embodiment of the present invention; and

FIG. 8 is an exemplary sectional view illustrating the weather strip to which the new sealing component has been mounted according to an exemplary embodiment of the present invention.

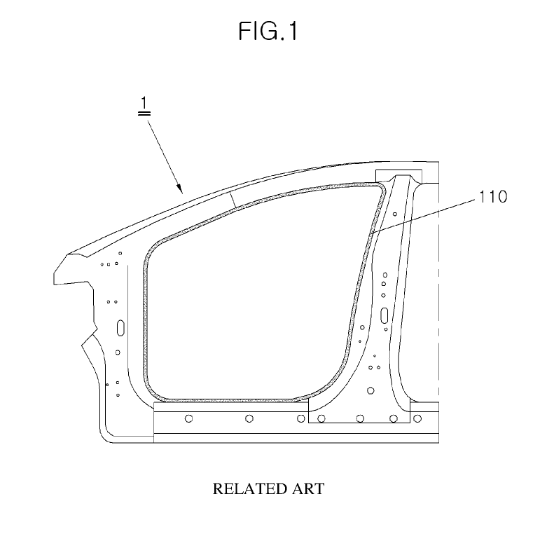

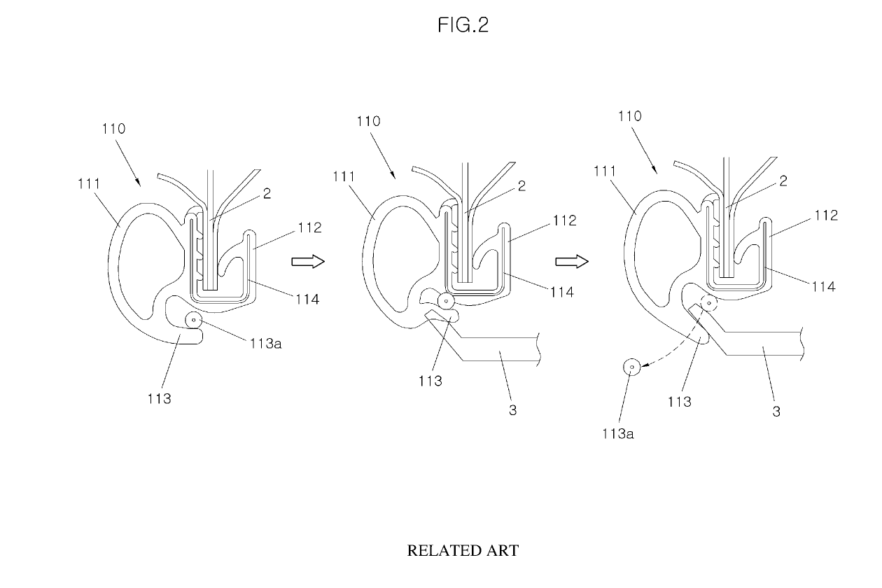

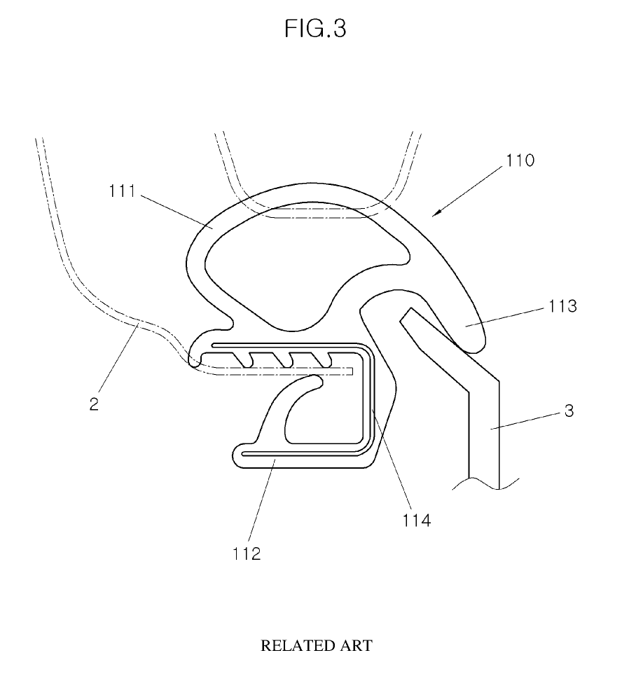

### DETAILED DESCRIPTION

Hereinafter, exemplary embodiments of the present invention will be described in detail with reference to the accompanying drawings so that those skilled in the art may easily practice the present invention. However, the present invention may be modified in various different ways and is not limited to the exemplary embodiments provided in the present description. In the accompanying drawings, portions unrelated to the description will be omitted in order to obviously describe the present invention, and similar reference numerals will be used to describe similar portions throughout the present specification.

In the drawings, the thickness of layers and regions are exaggerated for clarity. Like reference numerals designate like elements throughout the specification. It will be understood that when an element such as a layer, film, region, or substrate is referred to as being “on” another element, it can be directly on the other element or intervening elements may also be present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The weather strip with a replaceable sealing component according to the present invention may include a flange holding component configured to position a body flange of a vehicle body and may include a frame installed therein, and a sealing component which has a convex (e.g., an outwardly curved) shape and connected at opposite edges thereof to the flange holding component. When the vehicle is manufactured, the sealing component may be formed as an initial sealing component 11 may be integrally formed with the flange holding component 12 to be removable from the flange holding component 12. After the initial sealing component 11 has been removed from the flange holding component 12, opposite edges of a replacement sealing component 11′ with an outwardly convex shape may be coupled to the respective opposite edges of the flange holding component 12 to substitute the replacement sealing component 11′ for the initial sealing component 11.

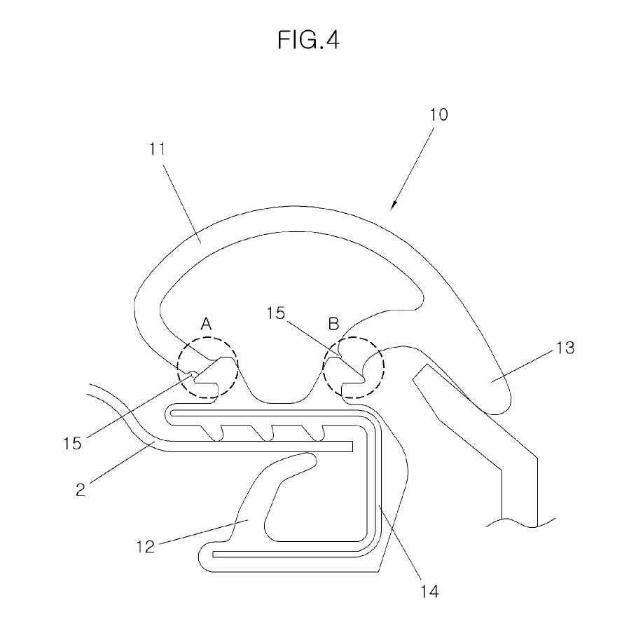

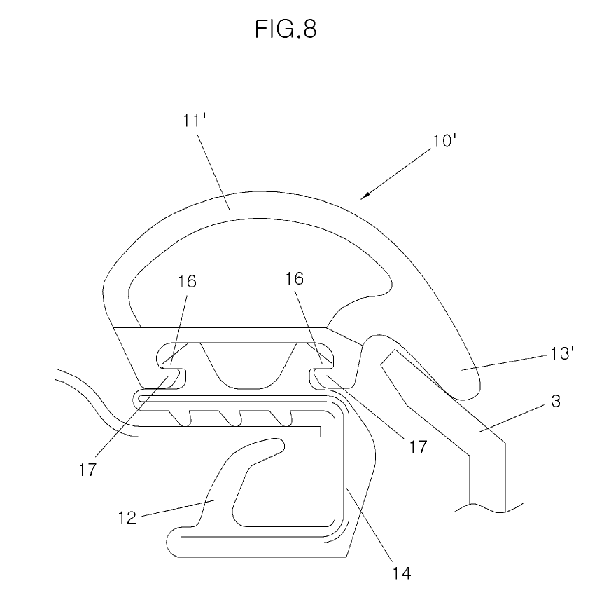

FIG. 4 illustrates the weather strip 10 with the initial sealing component 11 when the vehicle is manufactured. FIG. 8 illustrates the weather strip 10′ with the replacement sealing component 11′.

First, the weather strip 10 provided when the vehicle is manufactured will be described below. The initial sealing component 11 may include an outwardly-curved cross-section and may seal the space between a vehicle body and a door of the vehicle. The initial sealing component 11 along with the flange holding component 12 may be formed in a tubular shape with a space (e.g., a cavity) defined therebetween. When the door is closed, the initial sealing component 11 may be interposed between the vehicle body and the door of the vehicle 1 to seal the passenger compartment of the vehicle from the exterior, to prevent noise or a foreign substance such as water or dust from entering the passenger compartment.

The flange holding component 12 may be integrally formed with the initial sealing component 11 at a side of the initial sealing component 11. The flange holding component 12 may have an approximate U shape and may hold a body flange 2 of the vehicle. Additionally, the flange holding component 12 along with the initial sealing component 11 may form a closed-curve cross-section. A hard frame 14 may be disposed in the flange holding component 12 to maintain sufficient stiffness of the flange holding component 12 when the hard frame holds the body flange 2.

An initial trim holding component 13 may extend from a predetermined portion of the initial sealing component 11. In particular, the initial trim holding component 13 may be formed when the weather strip 10 and an interior trim 3 are installed. The initial trim holding component 13 may extend from the initial sealing component 11 toward the interior trim 3 and may have a shape that includes an edge of the initial trim holding component 13 that covers the surface of the trim 3.

The weather strip 10 having the above-mentioned configuration may be coupled to the vehicle to couple to the body flange 2 of the vehicle 1 to the flange holding component 12. Subsequently, the interior trim 3 may be installed. The initial trim holding component 13 may be removed from the trim 3 by a method that uses a pull cord to dispose the initial trim holding component 13 on the exterior surface of the trim 3. In other words, the weather strip 10 and the interior trim 3 may be installed on the vehicle body.

Furthermore, the weather strip 10 according to the present invention may include a structure capable of replacing the sealing component. For example, a structure may provide for replacement of the initial sealing component 11 with a new sealing component and may be formed on the junction between the initial sealing component 11 and the flange holding component 12. In other words, during the vehicle manufacturing process, as described above, the trim 3 may be mounted after the weather strip 10 has been installed on the vehicle body. The present invention allows the sealing component to be replaced with a new sealing component without separating the trim 3 from the vehicle body, for example, when contaminated, defective, or damaged to the weather strip 10.

When the initial sealing component 11 is contaminated or damaged or is defective, the sealing component, which is connected to the flange holding component 12 when the weather strip 10 is produced, may be replaced with a new one. For example, the initial sealing component 11 may be separated from the flange holding component 12 and a new replacement sealing component 11′ may be coupled to the flange holding component 12.

To allow the initial sealing component 11 to be more easily separated from the flange holding component 12, a cut out portion 15 may be formed between the initial sealing component 11 and the flange holding component 12. The cut out portion 15 may include a portion depressed within the junction between the initial sealing component 11 and the flange holding component 12. Since the cross-sectional area of a portion of the initial sealing component 11 in which the cut out portion 15 is formed may be less than that of the other portions, the initial sealing component 11 may more easily be removed from the flange holding component 12.

Furthermore, a locking hook 16 may be formed on each of the opposite edges of the flange holding component 12. The replacement sealing component 11′ may be coupled to the flange holding component 12. The replacement sealing component 11′ may also have an outwardly curved or convex shape. When the replacement sealing component 11′ is coupled to the flange holding component 12, the replacement sealing component 11′ and the flange holding component 12 may form a tubular shape, and may thus provide a sealed barrier.

Moreover, coupling hooks 17, locked to the respective locking hooks 16, may be formed on respective opposite edges of the replacement sealing component 11′, for example, portions may be coupled to the flange holding component 12. The replacement sealing component 11′ and the flange holding component 12 may be coupled and integrated with each other by the coupling hooks 17 and the locking hooks 16. In particular, the coupling hooks 17 may be formed on the opposite edges of the replacement sealing component 11′ and the hooks may be positioned inward. In other words, the locking hooks 16 may be formed to be positioned toward the exterior of the flange holding component 12. The replacement sealing component 11′ may be coupled to the flange holding component 12 by coupling the coupling hooks 17 to the respective locking hooks 16.

The locking hooks 16 and the coupling hooks 17 may be formed from material that has a high hardness to be more reliably coupled to each other to enable integration of the replacement sealing component 11′ and the flange holding component 12 with each other. For example, the portions on which the locking hooks 16 and the coupling hooks 17 are formed may be formed from thermoplastic elastomer (TPE) or ethylene propylene diene monomer (EPDM) or the like with a hardness greater than typical synthetic rubber. In particular, high-hardness EPDM solid may be provided as the EPDM.

Furthermore, the coupling hooks 17 formed on the replacement sealing component 11′ may connect the opposite edges of the replacement sealing component 11′ to each other to enable the replacement sealing component 11′ and the coupling hooks 17 to form a tubular shape. A replacement trim-holding component 13′ may extend from a predetermined portion of the replacement sealing component 11′ toward the interior trim 3. When the replacement sealing component 11′ is coupled to the flange holding component 12, the replacement trim-holding component 13′ may be in close contact (e.g., abutting contact) with the edge of the trim 3 disposed adjacent to the replacement sealing component 11′. Accordingly, the space between the weather strip 10 and the trim 3 may be reduced.

Hereafter, the operation of the weather strip with the replaceable sealing component according to the present invention having the above-mentioned configuration will be described.

With regard to installation of the weather strip with the replaceable sealing component according to the present invention, when the vehicle is manufactured, the weather strip 10 having the initial sealing component 11 and the flange holding component 12 formed integrally with each other may be installed on the vehicle 1. Thereafter, the interior trim 3 may be mounted to the vehicle body. The initial trim holding component 13 may be removed from or extracted out the trim 3, and the installation of the weather strip 10 and the interior trim 3 may be completed.

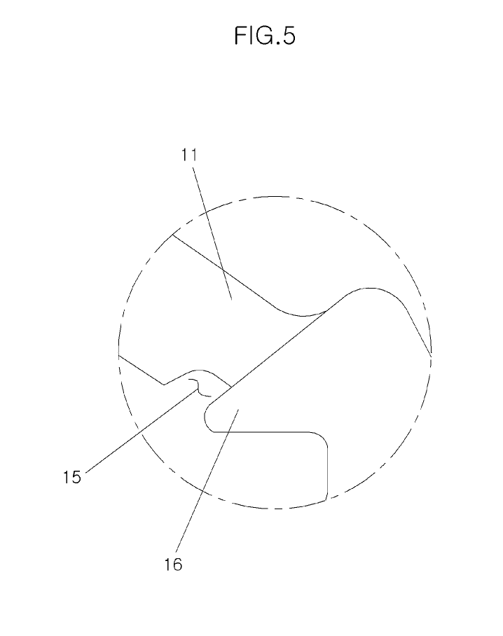

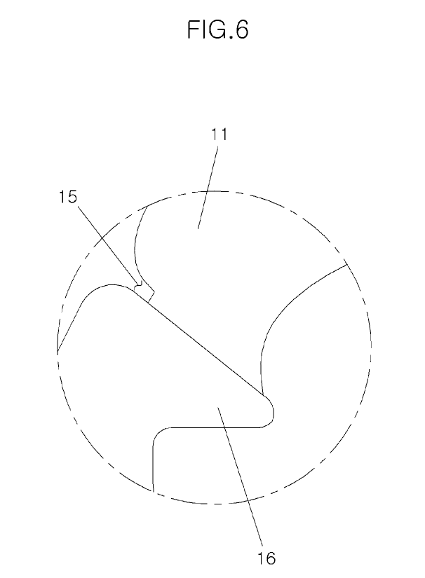

When the weather strip 10 requires replacement due to contamination, defect, damage, etc., the initial sealing component 11 and the initial trim holding component 13 may be removed (e.g., cut out of or other removing technique) from the weather strip 10. The replacement sealing component 11′ may then be mounted to the weather strip 10. As shown in detail in FIGS. 5 and 6, the cut out portion 15 (e.g., the removed portion), with the cross-sectional area that corresponds to a portion of the initial sealing component 11 may be less than that of the other portions thereof, and may be formed in the junction between the initial sealing component 11 and the flange holding component 12. Therefore, the initial sealing component 11 may be removed from the flange holding component 12 through the cut out portion 15. Accordingly the flange holding component 12 of the weather strip 10 may remain on the vehicle 1 during replacement.

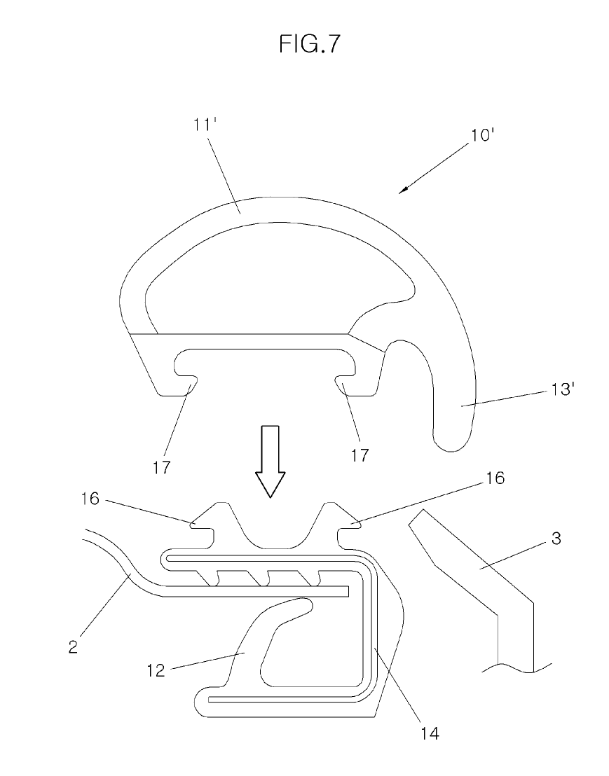

Thereafter, as shown in FIG. 7, the replacement sealing component 11′ may be coupled to the flange holding component 12. The replacement sealing component 11′ and the flange holding component 12 function as the new weather strip 10′. When the replacement sealing component 11′ is coupled to the flange holding component 12, the replacement trim-holding component 13′ formed on the predetermined portion of the replacement sealing component 11′ may also contact the trim 3, to reduce the space between the weather strip 10′ and the trim 3.

Moreover, the weather strip according to the present invention provides a substantially similar effect as replacement of the entirety of the weather strip and may be obtained by removal (e.g., cutting) of the initial sealing component 11 and mounting the replacement sealing component 11′ to the flange holding component 12 without removal of the trim 3.

As described above, in a weather strip with a replaceable sealing component according to the present invention, when replacement of the weather strip is required, a sealing component may be replaced while the other components such as a flange holding component may remain intact. Therefore, the weather strip may be replaced without disassembling an interior trim from a vehicle body. The time and effort required to replace the weather strip with may be reduced.

While the present invention has been described with respect to the specific exemplary embodiments, it will be apparent to those skilled in the art that various changes and modifications may be made without departing from the spirit and scope of the invention as defined in the following claims.

What is claimed is:

1. A weather strip with a replaceable sealing component, comprising:
a flange holding component configured to hold a body flange of a vehicle body, with a frame installed in the flange holding component; and
a sealing component having an convex curved shape and connected at opposite edges thereof to the flange holding component,
wherein when a vehicle is manufactured, the sealing component is formed as an initial sealing component integrally formed with the flange holding component to be removable from the flange holding component, and
wherein after the initial sealing component has been removed from the flange holding component, opposite edges of a replacement sealing component having a convex shape are coupled to the respective opposite edges of the flange holding component to substitute the replacement sealing component for the initial sealing component.

2. The weather strip of claim 1,
wherein a cut out portion is formed in a junction between the initial sealing component and the flange holding component, the cut out portion having a cross-sectional area less than cross-sectional areas of other portions, and
wherein the initial sealing component is separated from the flange holding component at the cut out portion.

3. The weather strip of claim 1, further comprising:
locking hooks and coupling hooks respectively formed on the opposite edges of the flange holding component and the opposite edges of the replacement sealing component that are coupled with each other,
wherein the replacement sealing component is coupled to the flange holding component by coupling the locking hooks formed on the flange holding component with the coupling hooks formed on the replacement sealing component.

4. The weather strip of claim 3, wherein the locking hooks and the coupling hooks have a hardness greater than a hardness of other portions of the replacement sealing component and the flange holding component.

5. The weather strip of claim 4, wherein the locking hooks and the coupling hooks are made of thermoplastic elastomer (TPE) or ethylene propylene diene monomer (EPDM).

6. The weather strip of claim 1, further comprising:
a replacement trim-holding component that extends from a predetermined portion of the replacement sealing component and abuts an interior trim mounted in a passenger compartment of the vehicle,
wherein, the interior trim has an edge disposed adjacent to the replacement sealing component.

7. The weather strip of claim 1, wherein the sealing component and the flange holding component 12 are formed in a tubular shape with a cavity defined therebetween.
